(19) United States
(12) Patent Application Publication
(10) Pub. No.: US 2013/0092592 A1
(43) Pub. Date: Apr. 18, 2013

(54) DEVICE FOR EXAMINING MOVING TABLETS

(71) Applicant: Uhlmann Pac-Systeme GMBH & Co. KG, Laupheim (DE)

(72) Inventor: Anton Singer, Laupheim (DE)

(73) Assignee: UHMANN PAC-SYSTEME GMBH & CO. KG, Laupheim (DE)

(21) Appl. No.: 13/649,212

(22) Filed: Oct. 11, 2012

(30) Foreign Application Priority Data
Oct. 13, 2011 (EP) EP 11185074.9

(51) Int. Cl. G01N 27/24; A61J 1/03

(52) U.S. Cl. CPC G01N 27/24; A61J 1/03
USPC 206/528; 324/663

(57) ABSTRACT

The device for examining moving tablets comprises a sensor element designed as a hollow body having a closed surrounding jacket of a conductive material, an open entrance side at a top and an open exit side at a bottom. The sensor element defines in its interior space a continuous path for the tablets extending from the entrance side to the exit side, and the jacket of the sensor element is grounded via a resistor. The device also comprises at least one pickup element of conductive material arranged near the outside surface of the jacket of the sensor element, the pickup element being galvanically isolated from the outside surface of the jacket of the sensor element.

### RELATED APPLICATIONS

The present patent document claims the benefit of priority to European Patent Application No. EP 11185074.9, filed Oct. 13, 2011, and entitled DEVICE FOR EXAMINING MOVING TABLETS″ the entire contents of each of which are incorporated herein by reference.

### FIELD AND BACKGROUND OF THE INVENTION

The present invention relates to a device for examining moving tablets.

Devices of this type are used in the pharmaceutical industry to count tablets as they are being transferred to containers, for example, or, in more complex embodiments, to examine the color, shape, and in some cases even the ingredients of the tablets.

A technique used frequently for this purpose is to drop the tablets or actively to move them between the opposing plates of a capacitor charged with a high-frequency alternating field. The passage of the tablet induces on the capacitor plates a dipole moment, which can be read by a suitable sensor. A device of this type is known, for example, from US 2009/0056825 A1.

Another design of a capacitive sensor of this type with more than two capacitor plates, which otherwise works according to the same principle as that just described above, is known, for example, from U.S. Pat. No. 6,504,387 B1.

The disadvantage of all these capacitive measurement methods is primarily that, to ensure that useful measurement results within acceptable tolerances can be obtained, the tablets must maintain a defined orientation as they are passing through the detector. The measurement results will deviate in particular when the tablets are rotating or when they depart from a certain favorable path, which means that the reliable detection of broken tablets and their subsequent ejection cannot be guaranteed under all circumstances.

### BRIEF SUMMARY

It is an object of the present invention to provide a device for examining moving tablets which can detect and evaluate the tablets regardless of their position in the sensor field and which can guarantee the reliable detection of broken tablets even at high throughputs.

According to an aspect of the invention, the device for examining moving tablets comprises a sensor element designed as a hollow body having a closed surrounding jacket of conductive material, an open entrance side at the top and an open exit side at the bottom. In its interior space, the sensor element defines a continuous path for the tablets extending from the entrance side to the exit side. In addition, the jacket is grounded via a resistor. The device also comprises at least one pickup element arranged near the outside surface of the jacket of the sensor element, the pickup element consisting of conductive material and being galvanically isolated from the outside surface of the jacket of the sensor element.

This design makes it possible to easily differentiate between whole tablets and broken ones and to guarantee a reliable classification of tablets regardless of the exact point at which they pass through the sensor and regardless of their orientation.

The evaluation can be improved by preferably connecting the pickup element to a converter and/or amplifier unit, which receives the voltage pulses generated in the pickup element as the tablets pass through the sensor element and converts and/or amplifies them to form an evaluable signal.

The device preferably also comprises an evaluation unit for evaluating the signals coming from the converter or amplifier unit so that a downstream sorting device can be actuated effectively. This evaluation unit is able to compare the nominal values of the converter or amplifier unit obtained for a certain type of tablet with the actual values supplied by the converter or amplifier unit.

A functionally reliable conversion and amplification process is ensured if, for example, the converter or amplifier unit is provided with an FET transistor, the gate of which is connected to the pickup element.

The sensor element is preferably designed as a short, hollow cylinder with a substantially circular cross section. Thanks to the circular form, the charges become uniformly spaced around the outside surface of the jacket of the sensor element as a tablet is passing through the sensor element. As a result, the charge can be detected at any desired point on the outside surface of the jacket without any deviation in the measurement results. A sensor element with a rectangular, especially a square, cross section is also suitable.

A particularly suitable material for the jacket of the sensor element is a conductive metal, especially high-grade steel or aluminum.

The same materials are also suitable for the pickup element.

Because the charge density on the outside surface of the jacket changes as a function of the size of the tablet, preferably several pickup elements with their associated converter or amplifier units are distributed around the outside surface of the jacket of the sensor element, wherein the pickup or evaluation electronic of each sensor is calibrated differently so that tablets of different sizes can be detected by the same sensor design.

The galvanic isolation between the sensor element and the pickup element is preferably achieved by an insulating element in the form of an insulating layer on the pickup element.

The jacket preferably comprises a thickness in the range of 0.2-0.8 mm and a diameter in the range of 10-60 mm. The distance between the entrance side and the exit side is preferably in the range of 5-20 mm. With these geometric dimensions, it is possible to detect a large number of different tablet shapes reliably and without any additional adjustments.

Installing a resistor in the range of 10-500 MΩ, preferably of 200-300 MΩ, between the jacket and ground prevents the buildup of an electrostatic charge, which would cause the signal to drift. At the same time, the resistor is necessary to ensure that the electric charges do not dissipate immediately, because otherwise the pickup element would not be able to detect any induction effect at all.

The pickup element is preferably designed as a plate, the jacket-facing surface of which comprises an area of approximately 5×5 mm. In this way, it is very easy to produce a charge separation in the pickup element which corresponds to the original information present in the interior of the sensor element.

An especially preferred application of the device for examining moving tablets lies in its integration into the filling tube of a tablet packaging unit. The tablets can thus be examined just before they are loaded into containers without the need for any fundamental change to the design of the tablet packaging unit.

### BRIEF DESCRIPTION OF THE DRAWINGS

Additional features and advantages of the present invention can be derived from the following description referring to the drawings.

FIG. 1 is a schematic cross-sectional view of a first embodiment of the device for examining moving tablets according to the invention as a tablet is dropping through it;

FIG. 2 is a cross-sectional view of the device of FIG. 1 in a plane perpendicular to the plane of the drawing of FIG. 1, including an enlarged detail;

FIGS. 3a-3c show voltage graphs obtained with the device for examining moving tablets according to the invention;

FIG. 4 is a schematic cross-sectional view of a tablet packaging unit with an integrated device for examining moving tablets according to the invention; and

FIG. 5 is a view, similar to that of FIG. 2, of a second embodiment of the device for examining moving tablets according to the invention.

### DETAILED DESCRIPTION OF SPECIFIC EMBODIMENTS

In the following, the term “tablet” is to be understood as any form of pharmaceutical product which is solid and contains pharmaceutically active ingredients. Examples include coated tablets, oblongs, capsules, etc.

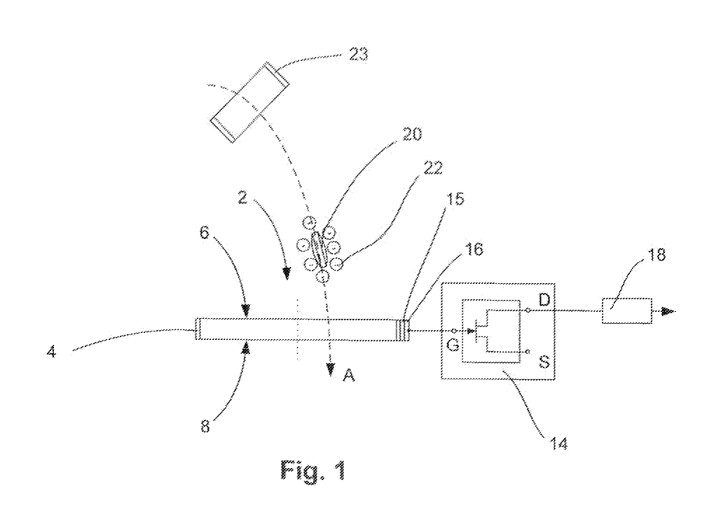

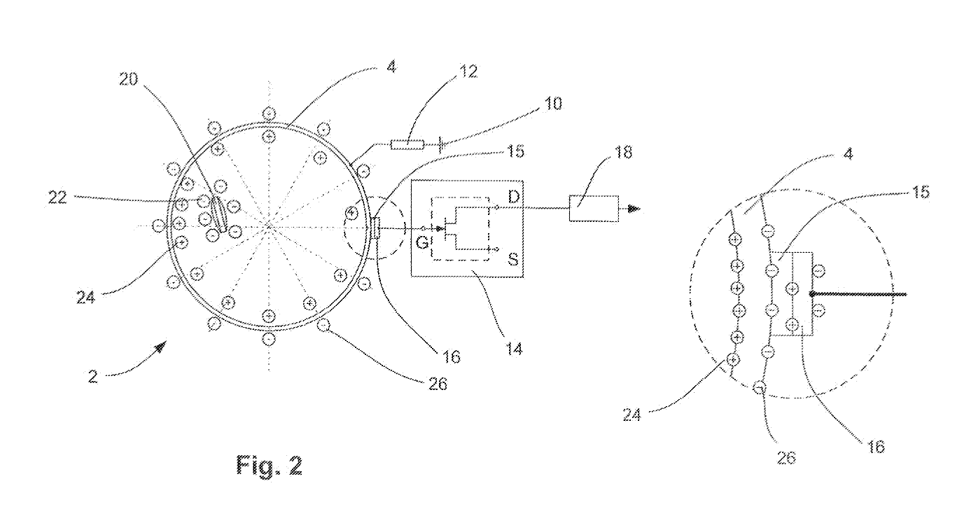

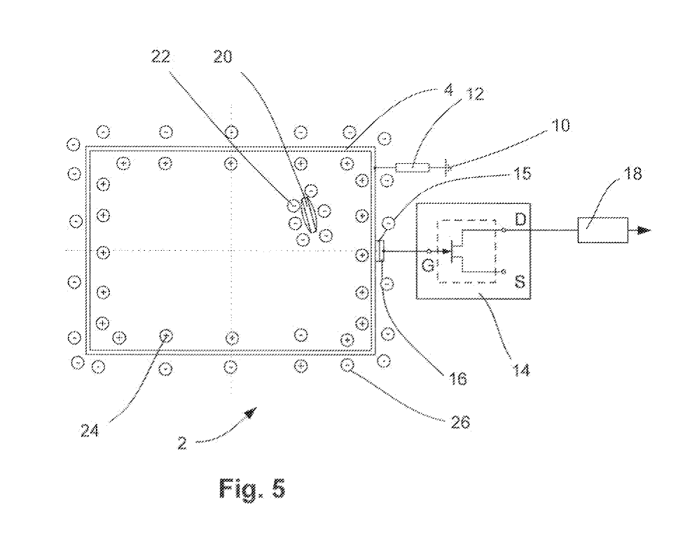

FIGS. 1 and 2 show two different views of a first embodiment of the device for examining moving tablets according to the invention. The device comprises a sensor element 2, which is designed as a hollow body and comprises a closed surrounding jacket 4 of conductive material. The sensor element 2 also comprises an open entrance side 6 at the top and an open exit side 8 at the bottom. In the preferred embodiment shown here, the sensor element 2 is designed as a short, hollow cylinder with a substantially circular cross section. In a different embodiment, the cross section of the sensor element 2 can be rectangular as shown in FIG. 5. In particular, it can be square.

The jacket 4 of the sensor element 2 is preferably made of metal such as high-grade steel or aluminum. The jacket 4 preferably comprises a thickness in the range of 0.2-0.8 mm and a diameter in the range of 10-60 mm. The distance between the entrance side 6 and the exit side 8 of the sensor element 2 is preferably in the range of 5-20 mm.

The jacket 4 of the sensor element 2 is grounded via a resistor 12, preferably a high-ohmic resistor. For this purpose, the outside surface of the jacket 4 is connected to ground 10 via the resistor 12. The resistor 12 has a resistance in the range of 10-500 MΩ, and preferably in the range of 200-300 MΩ.

The device for examining moving tablets also comprises at least one pickup element 16 of conductive material arranged near the outside surface of the jacket 4 of the sensor element 2. The signals generated by this pickup element 16 are processed by a converter and/or amplifier unit 14.

The pickup element 16, like the jacket 4 of the sensor element 2, is made of metal, preferably of high-grade steel or aluminum. The pickup element 16 is preferably designed as a plate. The surface of this plate which faces the jacket 4 preferably has an area of approximately 5×5 mm.

The pickup element 16 is isolated galvanically from the outside surface of the jacket 4 of the sensor element 2. An insulating element 15, preferably in the form of an insulating layer on the pickup element 16, is used to isolate the sensor element 2 galvanically from the pickup element 16. This layer can be provided in the form of a strip of insulating adhesive tape, for example. Many other types of insulating elements 15, however, can also be considered.

Several pickup elements 16 can also be arranged around the outside surface of the jacket 4 of the sensor element 2. In this case, preferably the same number of converter or amplifier units 14 will also be provided. Each sensor path is preferably calibrated differently.

The converter or amplifier unit 14 can be designed in a wide variety of ways. The important point here is that the charge separation caused by double induction in the pickup element 16 upon passage of a tablet 20 through the sensor element 2 is subjected to further processing, wherein the voltage pulses in the pickup element 16 serve as the starting point for the further conversion/amplification.

In the embodiment shown here by way of example, the converter or amplifier unit 14 is an FET transistor, the gate G of which is connected to the pickup element 16. Other types of transistors, possibly with additional voltage terminals, are also conceivable. It is also possible to conduct additional signal processing measures (inversion, smoothing, potentiation, etc.) upstream or downstream of the converter or amplifier unit 14.

The converter or amplifier unit 14 is preferably connected to an evaluation unit 18 for evaluation of the signals generated by the converter or amplifier unit 14. This evaluation unit 18 is able to compare the nominal values of the converter or amplifier unit 14 obtained for a certain type of tablet with the actual values supplied by the converter or amplifier unit 14. In the example shown here, the signal from the drain D of the FET transistor is sent to the evaluation unit 18. On the basis of the result of the evaluation unit 18, it is then possible to actuate an ejector unit (not shown) to eject the tablets classified as “bad”.

In the following, the principle on which the device for examining moving tablets operates will be described on the basis of FIGS. 1 and 2. Before they are loaded into containers, the tablets 20 are usually already carrying a defined electrostatic charge 22. This charge arises, for example, during the transport of the tablets 20 along a vibrating chute or at other points of the transport route and is attributable primarily to friction. Because the surface areas of whole tablets 20 differ from those of broken ones, the corresponding individual charges will also be different, as will the electrical field strengths on their surfaces. The device according to the invention can now use this charge as a means of examining the tablets 20.

If the tablets 20 are not already carrying a sufficient charge 22 by themselves, a tablet-charging unit 23 can be installed upstream of the device.

The tablet 20 now moves along a continuous path A through the sensor element 2. In the example of FIG. 1, this is done simply in free fall. As the tablet 20 passes through the interior space of the sensor element from the entrance side 6 to the exit side 8, the charges 22 which are present on the tablets 20 generate by induction a charge separation in the electrically conductive jacket 4 and thus an accumulation of charges 24 on the internal surface of the jacket 4 (FIG. 2) with signs opposite those of the charges 22 on the tablets 20. In other words, as the tablets 20 fall through the sensor element 2, their electrostatic fields create a charge separation by induction. The charge density of the charges 24 generated by the charge separation on the internal surface of the jacket 4 is greater in the immediate vicinity of the electrically charged tablet 20 than it is in areas of the internal surface of the jacket 4 which are farther away, as can be seen in FIG. 2.

On the outside surface of the jacket 4, however, the charge separation allows the charges 26, the signs of which are the same as those of the charges 22 of the tablet 20, to shift their locations. In the case of a ring-shaped jacket 4, the charge density on the outside surface of the jacket 4 therefore becomes uniform.

This means that equal-sized subsections of the outside surface of the jacket 4 all have the same partial electric field strength, and the sum of these partial field strengths is the same as the electrostatic field strength present in the interior of the jacket 4. The level of the charge density on the outside surface of the jacket 4 is determined by the charge 22 of the falling tablet 20. The partial field strength in each section of the outside surface of the jacket 4 is therefore directly proportional to the charge of the tablet 20 passing through the sensor element 2.

Thus the exact point where the tablet 20 passes through the interior space of the sensor element 2 has no effect on the electrostatic field strength generated in each of the subsections of the outside surface of the jacket 4.

This uniform electrostatic field strength on the outside surface of the jacket 4, which contains the original information of the charge of the tablet 20, now brings about in turn, by induction, a charge separation in the electrically conductive pickup element 16, as can be seen especially clearly in the enlarged diagram on the right in FIG. 2.

The voltage pulses thus arising are converted and/or amplified as appropriate in the converter and/or amplifier unit 14 and transmitted to the evaluation unit 18. The important point here is that the pickup element 16 and the jacket 4 are galvanically isolated from each other. The high-ohmic grounding of the jacket 4 via the resistor 12 prevents the buildup of an electrostatic charge, which would result in signal drift. At the same time, the resistor 12 ensures that the electrical charges 26 forming on the outside surface of the jacket 4 do not dissipate immediately, so that the pickup element 16 is able to detect an induction effect at all.

The evaluation unit 18 now compares the actual values transmitted from the converter or amplifier unit 14 with stored nominal values for a corresponding type of tablet. The nominal values can be obtained preferably by test runs with intact tablets as part of a calibration procedure.

A deviation from the given nominal value (e.g., with respect to the signal amplitude or the integral of the signal curve) by a predetermined amount or percentage makes it possible for the sensor element 2 to detect a falling broken tablet and for a downstream ejection device (not shown) to remove the broken tablet. Because the charge alternations occur very quickly, each tablet 20 can be evaluated before the next tablet 20 reaches the sensor element 2.

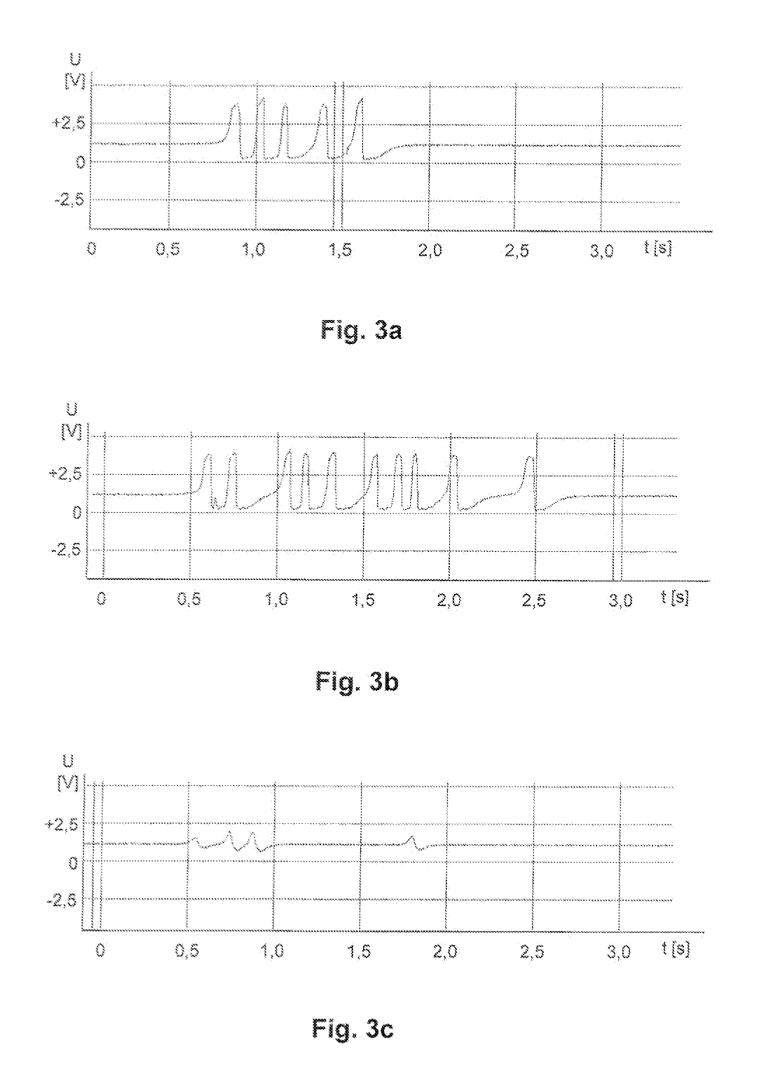

FIG. 3a shows the plot of the voltage signals (in V) coming from the converter or amplifier unit 14 versus time (in s) for five intact tablets. It is easy to see the almost completely uniform shape and height of the corresponding peaks.

FIG. 3b shows an identical graph for ten intact tablets, whereas FIG. 3c shows the graph for four pieces of broken tablets. Provided that a suitable threshold value is selected, it is therefore possible to detect every clinically relevant instance of tablet breakage and thus to eject the corresponding broken pieces. It is especially important to note here that neither the orientation of the tablet, its trajectory, nor the exact point where it passes through the sensor element 2 has any significant effect on the measurement result.

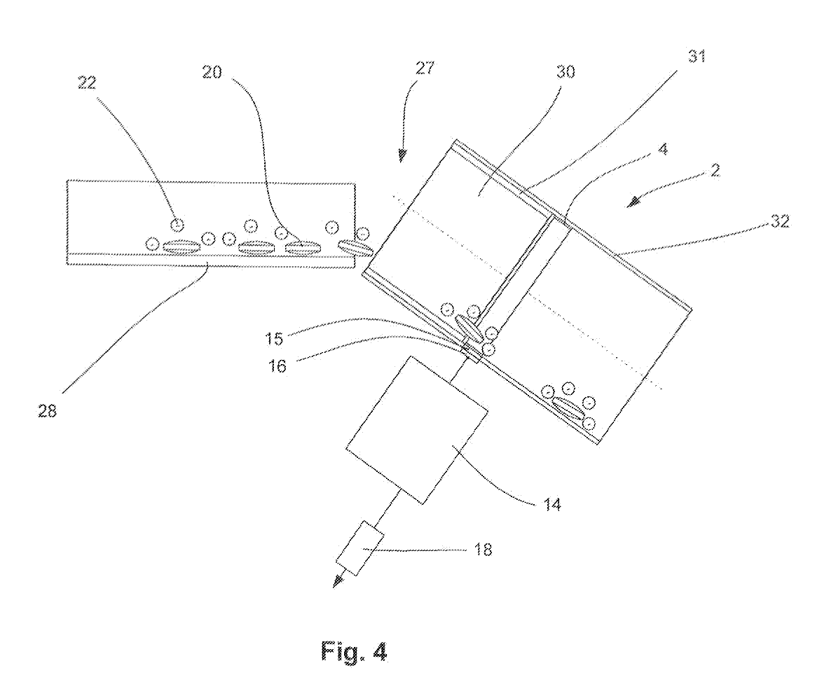

FIG. 4 shows another arrangement of the device for examining moving tablets in a tablet packaging unit 27. The tablet packaging unit 27 comprises an oscillating chute 28, by which the tablets 20 are transported to a filling tube 30. The sensor element 2 is integrated into the jacket 32 of the filling tube 30. The jacket 32 usually consists of insulating plastic. In the filling tube 30, upstream of the sensor element 2, a collar-like insert 31 of metal can be provided, over which the tablets 20 slide. For the sake of clarity, not all of the elements of the device for examining moving tablets are shown. Nevertheless, the design of the device corresponds to that of the device shown in FIGS. 1 and 2 or FIG. 5.

The important aspect of this embodiment is that the jacket 4 of the sensor element 2 is set back slightly from the upstream interior section of the filling tube 30, i.e., from the inside surface of the insert 31 in the examples shown here, so that the tablets 20 do not touch the inside surface of the jacket 4 as they pass through the filling tube 30. If they did, the measurements could be falsified. Accordingly, the inside radii of the jacket 32, i.e., the radius of the insert 31 in the filling tube 30 and the radius of the jacket 4 of the sensor element 2, must be selected properly with respect to each other. In addition the angle of the filling tube 30 and the speed of the tablets 20 are also factors which must be considered. Aside from that, the way in which the device examines moving tablets is identical to that described above.

In the preferred embodiment shown here, only one pickup element 16 has been illustrated. It is possible, however, to provide several pickup elements 16, such as two or four pickup elements 16, and to distribute them uniformly around the sensor element 2. The shape of the jacket 4 of the sensor element 2 can also be different from that of the embodiments shown. Finally, the pickup element 16 can be farther away from the jacket 4 than shown in the drawings.

1. A device for examining moving tablets, comprising:
a sensor element designed as a hollow body having a closed surrounding jacket of a conductive material, an open entrance side at a top of the hollow body and an open exit side at a bottom of the hollow body, wherein the sensor element defines in an interior space thereof a continuous path for the tablets, the continuous path extending from the entrance side to the exit side, and wherein the jacket is grounded via a resistor; and
at least one pickup element of conductive material arranged near an outside surface of the jacket of the sensor element, the pickup element being galvanically isolated from the outside surface of the jacket of the sensor element.

2. The device according to claim 1, wherein the pickup element is connected to a converter or amplifier unit, which receives voltage pulses generated in the pickup element upon passage of a tablet through the sensor element and converts or amplifies them to form an evaluable signal.

3. The device according to claim 2, wherein it further comprises an evaluation unit, which receives the signals from the converter or amplifier unit and compares nominal values of the converter or amplifier unit obtained for a certain type of tablet with actual values supplied by the converter or amplifier unit.

4. The device according to claim 2, wherein the converter or amplifier unit comprises an FET transistor, a gate of which is connected to the pickup element.

5. The device according to claim 1, wherein the sensor element is designed as a short hollow body with a substantially circular or rectangular cross section.

6. The device according to claim 1, wherein the jacket of he sensor element is made of metal.

7. The device according to claim 1, wherein the pickup element is made of metal.

8. The device according to claim 1, wherein several pickup elements are distributed around the outside surface of the jacket of the sensor element.

9. The device according to claim 1, wherein a galvanic separation between the sensor element and the pickup element is achieved by an insulating element in the form of an insulating layer on the pickup element.

10. The device according to claim 1, wherein the jacket has a thickness in the range of 0.2-0.8 mm and a diameter in the range of 10-60 mm.

11. The device according to claim 1, wherein a distance between the entrance side and the exit side is in the range of 5-10 mm.

12. The device according to claim 1 wherein the resistor between the jacket and ground has a resistance in the range of 0-500 MΩ.

13. The device according to claim 12, wherein the resistor between the jacket and ground has a resistance in the range of 200-300 MΩ.

14. The device according to claim 1, wherein the pickup element is designed as a plate.

15. A tablet packaging unit comprising:
at least one filling tube; and
at least one device for examining moving tablets integrated into the at least one filling tube;
wherein the at least one device for examining moving tablets comprises:
a sensor element designed as a hollow body having a closed surrounding jacket of a conductive material, an open entrance side at a top of the hollow body and an open exit side at a bottom of the hollow body, wherein the sensor element defines in an interior space thereof a continuous path for the tablets, the continuous path extending from the entrance side to the exit side, and wherein the jacket is grounded via a resistor; and
at least one pickup element of conductive material arranged near an outside surface of the jacket of the sensor element, the pickup element being galvanically isolated from the outside surface of the jacket of the sensor element.
